(19) United States
(12) Patent Application Publication
(10) Pub. No.: US 2003/0150338 A1
(43) Pub. Date: Aug. 14, 2003

(54) Food handling device

(76) Inventors: Ernest Zavoral, Canfield, OH (US); Mary Jane Slater, Butler, PA (US)

Correspondence Address: FAY, SHARPE, FAGAN,, MINNICH & McKEE, LLP, 7th Floor, 1100 Superior Avenue, Cleveland, OH, 44114-2516, US

(21) Appl. No.: 10/308,856

(22) Filed: Dec. 3, 2002

Related U.S. Application Data
(60) Provisional application No. 60/337,392, filed on Dec. 3, 2001.

(51) Int. Cl. A23P 1/00

(52) U.S. Cl. 99/426

(57) ABSTRACT

A food handling apparatus (10) has a support member such as an ope net (12) for supporting a food product and allowing fluid such as meat juices, cooking water, etc. to pass therethrough. Flexible handles (16) extend from opposite ends of the net to allow a user to lift the food product when supported in the net.

### FIELD OF THE INVENTION

The present invention is directed to a handling device for use in conjunction with food items.

### BACKGROUND OF THE INVENTION

Many difficulties exist in the handling of food items, particularly when such food items are heated, so as to prevent the touching of the food items by a bare hand. For example, it is desirable during cooking to allow a food item, such as corn-on-the-cob or ham, to drain of excess water after boiling. Likewise, it is often desirable to lift and transfer poultry, for example, from one pan or dish to another. However, such a food item cannot be touched by the bare hand because of the possibility of burning. Normally, a person cooking a food item uses an ordinary kitchen utensil such as a fork or tong in order to lift and carry a food item and to prevent burning. However, the use of many such conventional kitchen utensils may create problems such as accidental slippage, dripping, maneuverability, etc.

It would be advantageous to be able to lift, transport, or carry food items in a safe and efficient manner while preventing the possibility of burning.

### SUMMARY OF THE INVENTION

The present invention is directed to a handling device for food items that can be used for simple lifting or carrying of food items and to prevent burning while cooking. Additionally, the present invention is directed to a device for food items that can be used for allowing the food item to drain without touching the food item.

The handling device comprises a net and a continuous binding attached to the net. The continuous binding defines a pair of handles preferably extending in opposite directions.

### BRIEF DESCRIPTION OF THE DRAWINGS

FIG. 1 is a perspective view of the food handling device.

FIG. 2 is a side view of the food handling device.

FIG. 3 is a side view of the binding.

FIG. 4 is a cross-sectional view of the binding attached to the net.

FIG. 5 is a top view of the binding attached to the net.

### DETAILED DESCRIPTION OF THE INVENTION

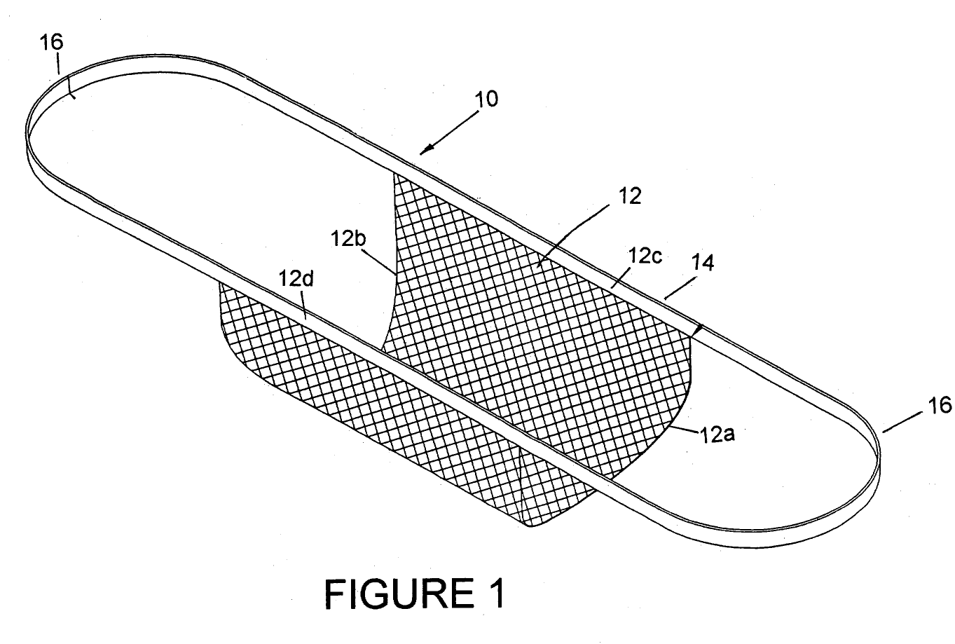

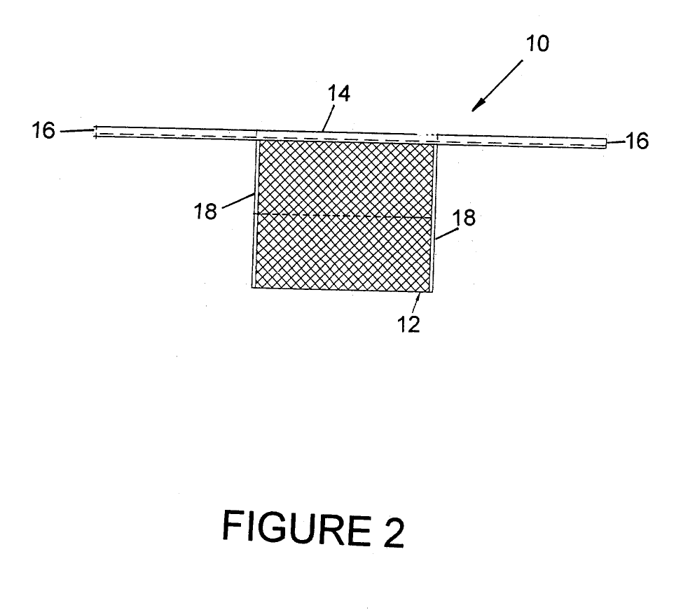

Referring to FIGS. 1 and 2, a handling device 10 is shown for use in carrying food items. The handling device 10 has a support member such as an open net portion 12 located generally in a central area of the handling device 10. The net 12 can be of various sizes and configurations and the openings in the net allow fluid to pass therethrough. For example, meat juices pass through the openings in the net, or water in which food items are cooked can freely pass through the net opening without adversely impacting on the cooking of the food item. Preferably, the net 12 has a generally rectangular shape, however, the net 12 can have other geometric or curved shapes. The net 12 can also be made from a variety of different fabric material. Preferably, the net 12 is formed from a material that is flexible and can withstand higher temperatures associated with cooking. Most preferably, the net 12 is formed from a cotton or cotton-blended material. The pattern of the net 12 can vary although orienting the mesh so that warp and weft strands that comprise the mesh extend along an angle relative to side edges 12a, 12b, and opposite ends 12c, 12d. The mesh angle is desirable since it permits the distance between opposed edges to accommodate different sized food items. Additionally, the mesh size of the net 12, i.e., the size of the openings in the net, can vary.

A binding 14 is attached to the net 12 in a manner to be described in greater detail below. The binding 14 provides strength and support to the net 12 in order to carry heavier food items. The binding 14 is attached to at least two sides of the net 12. Preferably, the binding 14 is stitched to the net 12. The attachment of the binding 14 to the net 12 provides the net 12 with overall greater strength than without the attached binding 14. Preferably, the binding 14 is continuous, although it is contemplated that the binding 14 may be non-continuous. The binding 14 can be formed from known fabric materials. Preferably, the binding 14 is formed from a cotton or cotton-blended material.

FIG. 2 shows the additional feature of at least one support 18 along the edges of at least one of the ends of the net 12. The net preferably has supports along the side edges 12a, 12b and/or ends 12c, 12d of the net. The support provides additional strength to the net so that the net may be able to carry heavier food items. The supports are attached along opposite edges of the net where the binding is not attached so as to provide additional support to those sides. Preferably, the supports are sewn, reinforced edges of the net.

The binding 14 is shaped to define a plurality of flexible handles 16. Preferably, each handle has a generally semi-circular shape or loop when the binding is continuous, although it is contemplated that the closed, continuous semi-circular handles can be separated into individual handles or straps. The continuous handles are preferred because a user can quickly and easily grasp a pair of handles (rather than four individual handles) and effectively support the food item. The chance of inadvertently dropping the food item is reduced as a result of using a pair of continuous handles. The handles extend from opposite ends of the net and as shown in the preferred embodiment are integrally secured along the side edges of the net. It will be appreciated that the material that forms the handles need not be integrally formed along the side edges of the net; however, such an arrangement is preferred for ease of manufacture.

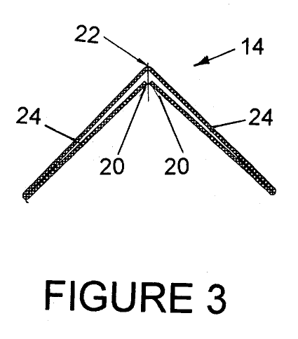

The binding is preferably attached to the net by folding the edge of the binding and the edge of the net, and sewing the binding to the net. FIG. 3 shows two opposing edges 20 of the binding 14 folded inward once so that the two edges 20 meet at a midpoint 22 to form two folded binding portions 24. The binding 14 is then folded at the midpoint 22 so that the two folded binding portions 24 define an opening. The opening defined by the two folded binding portions 24 has a closed end defined by the midpoint 22 and an open end defined by the end opposite of the midpoint 22.

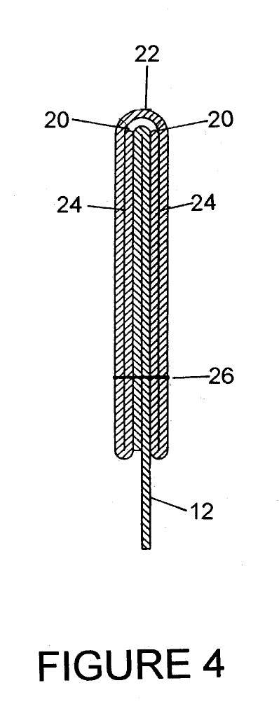

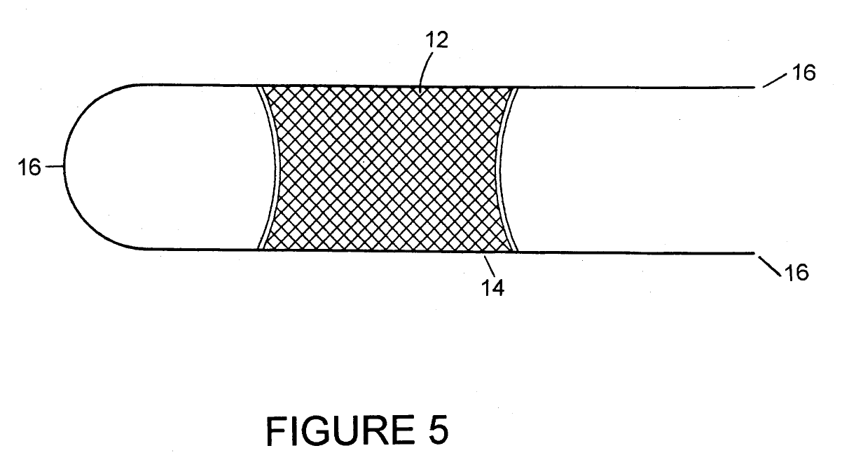

FIG. 4 shows the attachment of the folded binding 14 to the net 12 by sewing. The edge of the net 12 is folded once and the folded portion of the net 12 is inserted through open end and into the opening defined by the two folded binding portions 24 of the binding 14. A plurality of stitches 26 sewn through the binding 14 and net 12 binds the folded portion of the net 12 with the folded portion of the binding 14. FIG. 5 shows the net 12 and binding 14 folded and sewn together. As shown in FIG. 5, the handle 16 can be one continuous handle or two separated handles. The two separated handles may be sewn together to form one continuous handle.

When the binding is attached to the net and the handling device is held from the handles, the net forms a generally arched shape. The arched shape of the net allows the handling device to hold food items on the net. Also, the net allows the draining of the food item if so desired. The handling devices shown may be used to carry food items such as turkeys, various rolls or roasts, ham, corn, etc. The nature of the material of the handling device allows the net to be positioned in place around the food item while it is being cooked and the handles left accessible to allow the food item to be easily removed from the pot or pan. When desired, a user simply grasps the handles and lifts the food item which is supported by the net. As the food item is securely lifted from the pot/pan, any fluid will pass through the net and thereby easily drain into the pot/pan, while the food item is transferred by the handles.

The invention has been described with reference to the preferred embodiments. Obviously, modifications and alterations will occur to others upon reading and understanding the preceding detailed description. It is intended that the invention be construed as including all such modifications and alterations.

Having thus described the invention, we claim:

1. A food handling apparatus comprising:
a flexible support member including a plurality of openings extending therethrough, the support member dimensioned to receive a food item;
flexible first and second handles secured to and extending from opposite ends of the support member for selectively lifting a food item received on the support member.

2. The apparatus of claim 1 wherein the support member is a net defined by interconnecting strands.

3. The apparatus of claim 2 wherein the strands are oriented at an angle relative to the opposite end of the support member.

4. The apparatus of claim 1 wherein the support member is a substantially rectangular net having first and second ends that extend substantially perpendicular to first and second side edges thereof, the net having an open mesh configuration defined by intersecting warp and weft strands that are angled relative to the ends and side edges.

5. The apparatus of claim 1 wherein at least one of the handles form a continuous loop that extends from a first side edge of the support member to a second side edge of the support member from one of the ends.

6. The apparatus of claim 1 wherein each handle forms a continuous loop at a respective end of the support member that extends from a first side edge of the support member to a second side edge of the support member.

7. The apparatus of claim 1 wherein the support member is a net having first and second ends that are reinforced and includes first and second flexible handles extending from the ends.

8. The apparatus of claim 7 wherein the handles are formed as semi-circular shapes extending from the first and second ends of the support member.

9. The apparatus of claim 8 wherein the net has first and second side edges that are reinforced.

10. The apparatus of claim 9 wherein the handles are integrally formed with the first and second side edges.

11. The apparatus of claim 10 wherein the net is formed of first and second sets of parallel strands that extend in non-orthogonal angles relative to the first and second ends and side edges.

12. The apparatus of claim 1 wherein the support member and handles are formed from a cotton or cotton-blended material.
